(19) United States
(12) Patent Application Publication
(10) Pub. No.: US 2020/0376340 A1
(43) Pub. Date: Dec. 3, 2020

(54) REHABILITATION TRAINING SYSTEM, REHABILITATION TRAINING SYSTEM CONTROL PROGRAM, AND REHABILITATION TRAINING SYSTEM CONTROL METHOD

(71) Applicant: TOYOTA JIDOSHA KABUSHIKI KAISHA, Toyota-shi (JP)

(72) Inventors: Issei NAKASHIMA, Toyota-shi (JP); Taiga MATSUMOTO, Nagoya-shi (JP); Eiichi SAITOH, Nagoya-shi (JP); Akihiro SAITO, Ota-ku (JP); Satoshi HIRANO, Nagoya-shi (JP); Shigeo TANABE, Toyoake-shi (JP); Takuma II, Nagoya-shi (JP)

(73) Assignee: TOYOTA JIDOSHA KABUSHIKI KAISHA, Toyota-shi (JP)

(21) Appl. No.: 16/850,181

(22) Filed: Apr. 16, 2020

(30) Foreign Application Priority Data
May 31, 2019 (JP) 2019-102474

(51) Int. Cl. A63B 24/00; A61H 3/00; A63B 71/06; A63B 22/02

(52) U.S. Cl. CPC A63B 24/0087; A61H 3/008; A63B 71/0622; A63B 2022/0094; A63B 22/02; A63B 24/0062; A63B 24/0075

(57) ABSTRACT

A rehabilitation training system includes a storage unit configured to store a plurality of training objective items, a first monitor installed at a position not visible from a position where a training person undergoes a training attempt and configured to display a training objective item of a first group from among the plurality of training objective items, a second monitor installed at a position visible from the position and configured to display a training objective item of a second group selected through the display on the first monitor from among the training objective items of the first group, and a control unit configured to control the training attempt to be undergone by the training person based on a specific training objective item selected through the display on the second monitor from among the training objective items of the second group.

### CROSS REFERENCE TO RELATED APPLICATIONS

This application is based upon and claims the benefit of priority from Japanese patent application No. 2019-102474, filed on May 31, 2019, the disclosure of which is incorporated herein in its entirety by reference.

### BACKGROUND

The present disclosure relates to a rehabilitation training system, a control program for the rehabilitation training system, and a control method for the rehabilitation training system.

A training support apparatus that provides an exercise program suitable for a user using personal information of the user is known (for example, see Japanese Unexamined Patent Application Publication No. 2017-27192).

### SUMMARY

A training person who undergoes rehabilitation training may feel reluctant or be discouraged to undergo rehabilitation training according to training objective items that are, for example, automatically selected by a training apparatus or forced upon the training person by a physical therapist. On the other hand, in order to achieve an expected training effect, it is not desirable to allow the training person to freely select the training objective items.

The present disclosure has been made to solve such a problem. The present disclosure provides a rehabilitation training system and the like capable of making a training person actively undergo rehabilitation training according to a training objective item expected to be effective.

A first example aspect of the present disclosure is a rehabilitation training system including a storage unit configured to store a plurality of training objective items; a first monitor installed at a position not visible from a position where a training person undergoes a training attempt and configured to display a training objective item of a first group from among the plurality of training objective items; a second monitor installed at a position visible from the position and displays a training objective item of a second group selected through the display on the first monitor from among the training objective items of the first group; and a control unit configured to control the training attempt to be undergone by the training person based on a specific training objective item selected through the display on the second monitor from among the training objective items of the second group.

An assistant who is a physical therapist or a physician can select a plurality of training objective items expected to be effective without letting the training person see it in consideration of the training person's condition and character. In other words, a training objective item that lowers the training person's motivation can be excluded. Then, the training person can actively select a training objective item from among candidates of the training objective items selected by the assistant. When the training attempt is controlled based on the training objective item thus selected in two phases, it is possible to enhance the training person's motivation and to achieve a large training effect.

In the above rehabilitation training system, the selection of the training objective item of the second group made through the display on the first monitor may be restricted from being executed so that the training objective item of the second group is selected by an assistant, not the training person. An assistant should determine what training is effective for the training person, and thus the training person may be restricted from selecting a training objective item.

Further, in the above rehabilitation training system, the storage unit may be configured to store a plurality of evaluation information pieces regarding an evaluation of the training attempt undergone by the training person, the first monitor may be configured to display an evaluation information piece of a first group from among the plurality of evaluation information pieces, and the second monitor may be configured to display an evaluation information piece of a second group selected through the display on the first monitor from among the evaluation information pieces of the first group. The evaluation on the training attempt undergone by the training person also affects the training person's motivation. On the other hand, when only an evaluation pleasing for the training person is given to the training person, the training person cannot understand what points should be considered when he/she performs rehabilitation training, and thus the training effect is reduced. However, when the assistant selects the evaluation information piece in consideration of the training person's condition and character in advance, it is possible to make the training person recognize an objective and an effect and feel comfortable to start rehabilitation training without losing his/her motivation.

At this time, the plurality of evaluation information pieces may include at least one of an evaluation comment on the training attempt, an evaluation value converted into a numerical value, and a video obtained by capturing a state of the training attempt. The evaluation information presented to the training person may be presented in various forms.

A second example aspect of the present disclosure is a control program of a rehabilitation training system causing a computer to execute: reading a training objective item of a preset first group from among a plurality of training objective items stored in a storage unit and displaying the training objective item of the first group on a first monitor installed at a position where the first monitor cannot be seen from a position where a training person undergoes a training attempt; receiving a selection of a training objective item of a second group from among the training objective items of the first group; displaying the training objective item of the second group on a second monitor installed at a position where the second monitor can be seen from the position; receiving a selection of a specific training objective item from among the training objective items of the second group; and controlling a training attempt to be undergone by the training person based on the selected specific training objective item. As described above, the rehabilitation training system controlled by such a control program can be expected to enhance the training person's motivation and also achieve a large training effect.

A third example aspect of the present disclosure is a method for controlling a rehabilitation training system. The method includes: reading a training objective item of a preset first group from among a plurality of training objective items stored in a storage unit and displaying the training objective item of the first group on a first monitor installed at a position where the first monitor cannot be seen from a position where a training person undergoes a training attempt; receiving a selection of a training objective item of a second group from among the training objective items of the first group; displaying the training objective item of the second group on a second monitor installed at a position where the second monitor can be seen from the position; receiving a selection of a specific training objective item from among the training objective items of the second group; and controlling a training attempt to be undergone by the training person based on the specific training objective item. As described above, the rehabilitation training system controlled by such a control method can be expected to enhance the training person's motivation and also achieve a large training effect.

According to the present disclosure, it is possible to provide a rehabilitation training system or the like capable of making a training person actively undergo rehabilitation training according to a training objective item expected to be effective.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic perspective view of a walking training apparatus according to an embodiment;

FIG. 2 is a schematic perspective view of a walking assistance apparatus;

FIG. 3 shows a system configuration of the walking training apparatus;

FIG. 4 shows an example of a selection screen of training objective items displayed on a management monitor;

FIG. 5 shows an example of a selection screen of training objective items displayed on a training monitor;

FIG. 6 shows an example of a selection screen of evaluation comments displayed on the management monitor;

FIG. 7 shows an example of a display screen of the evaluation comments displayed on the training monitor;

FIG. 8 shows an example of a selection screen of the training video displayed on the management monitor;

FIG. 9 shows an example of a display screen of a training video displayed on the training monitor; and

FIG. 10 shows a processing flow of a series of training attempts.

### DESCRIPTION OF EMBODIMENTS

The present disclosure will be described below through the embodiments of the disclosure, but the disclosure according to the claims is not limited to the following embodiments. Further, all of the configurations described in the embodiments are not necessarily essential as means for solving the problem.

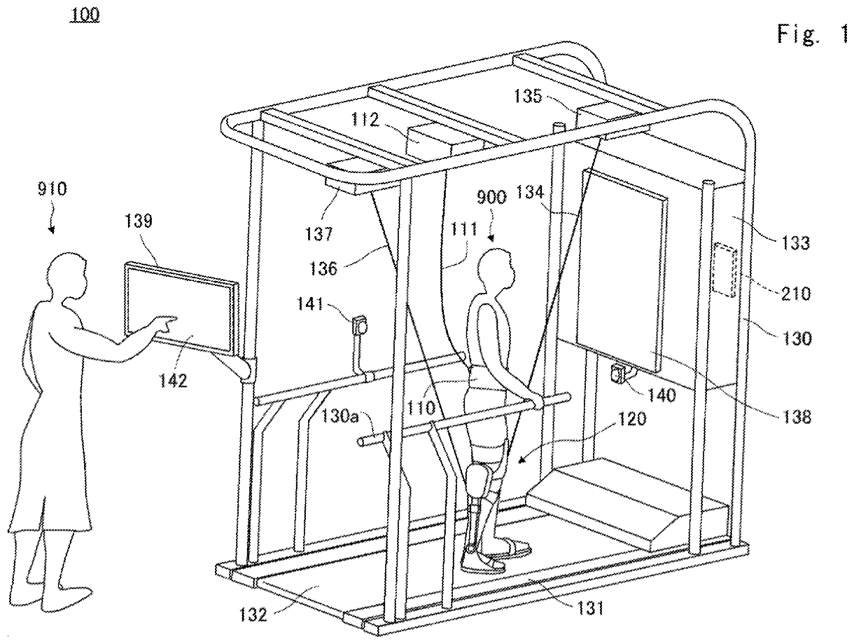

FIG. 1 is a schematic perspective view of a walking training apparatus 100 according to this embodiment. The walking training apparatus 100 is an example of a rehabilitation training system, and is an apparatus for a training person 900, who is a hemiplegic patient suffering from paralysis in one of his/her legs, to undergo walking training. The walking training apparatus 100 mainly includes a control panel 133 attached to a frame 130 forming an overall framework, a treadmill 131 on which the training person 900 walks, and a walking assistance apparatus 120 worn on the diseased leg, i.e., the leg on the paralyzed side of the training person 900.

The frame 130 is disposed on the treadmill 131 mounted on a floor surface in a standing state. The treadmill 131 rotates a ring-shaped belt 132 by a motor (not shown). The treadmill 131 is an apparatus for urging the training person 900 to walk. The training person 900, who is to undergo walking training, rides on the belt 132 and tries to walk according to the movement of the belt 132.

The frame 130 supports the control panel 133 for housing an overall control unit 210 that controls a motor and a sensor, and a training monitor 138 which is, for example, a liquid crystal panel for presenting information about training attempts to the training person 900. The training monitor 138 is installed in such a way that the training person 900 can visually recognize the training monitor 138 while walking on the belt 132 of the treadmill 131. The frame 130 supports a front pulling unit 135 in the vicinity of above and in front of the training person 900's head, supports a harness pulling unit 112 in the vicinity of above the training person 900's head, and supports a rear pulling unit 137 in the vicinity of above and behind the training person 900's head. The frame 130 also includes a handrail 130a for the training person 900 to grasp.

A front camera unit 140 captures images of the training person 900 at an angle of view at which a gait of the training person 900 can be recognized from the front. A side camera unit 141 captures images of the training person 900 at an angle of view at which a gait of the training person 900 can be recognized from the side. The front camera unit 140 and the side camera unit 141 according to this embodiment each include a set of a lens and an image pickup device that provide an angle of view at which the training person 900's whole body standing on the belt 132 including his/her head can be captured. The image pickup device is, for example, a CMOS image sensor, and converts an optical image formed on an image forming surface into an image signal. The front camera unit 140 is installed in the vicinity of the training monitor 138 so that it faces the training person 900. The side camera unit 141 is installed on the handrail 130 a so as to capture images of the training person 900 from the side.

One end of a front wire 134 is connected to a winding mechanism of the front pulling unit 135 and the other end of the front wire 134 is connected to the walking assistance apparatus 120. The winding mechanism of the front pulling unit 135 winds up and pays out the front wire 134 according to the movement of the diseased leg by turning on or off the motor (not shown). Similarly, one end of a rear wire 136 is connected to a winding mechanism of the rear pulling unit 137 and the other end of the rear wire 136 is connected to the walking assistance apparatus 120. The winding mechanism of the rear pulling unit 137 winds up and pays out the rear wire 136 according to the movement of the diseased leg by turning on or off the motor (not shown). By such cooperative operations performed by the front pulling unit 135 and the rear pulling unit 137, the load (e. g. , the weight) of the walking assistance apparatus 120 is cancelled out and hence does not act as a burden on the diseased leg, and a swinging motion of the diseased leg is assisted according to a set level.

For example, an operator 910 who is a training assistant sets an assisting level to a high value for a training person having severe paralysis. The operator 910 is a physical therapist or physician having an authority to select, correct, or add a setting item of the walking training apparatus 100. When the assisting level is set high, the front pulling unit 135 winds up the front wire 134 with a relatively strong force in synchronization with the swinging motion of the diseased leg. When the assistance becomes unnecessary as the training proceeds, the operator sets the assisting level to a minimum value. When the assisting level is set to the minimum value, the front pulling unit 135 winds up the front wire 134 with a force by which the weight of the walking assistance apparatus 120 is just cancelled in synchronization with the swinging motion of the diseased leg.

The walking training apparatus 100 includes a safety apparatus. The safety apparatus is composed of safety brace 110, a harness wire 111, and a harness pulling unit 112 as main components. The safety brace 110 is a belt wound around the training person 900's abdomen and fixed to his/her waist by, for example, a hook-and-loose fastener. One end of the harness wire 111 is connected to the safety brace 110, and the other end of the hardness wire 111 is connected to the winding mechanism of the harness pulling unit 112. The winding mechanism of the harness pulling part 112 winds and unwinds the harness wire 111 by turning on and off a motor (not shown). With such a configuration, when the training person 900 greatly loses his/her posture, the safety apparatus winds up the harness wire 111 in accordance with an instruction from the overall control unit 210 that has detected a balance losing movement of the training person 900, and supports the training person 900's upper body by the safety brace 110.

The management monitor 139 is attached to the frame 130 and is a display apparatus for the operator 910 to monitor and operate the walking training apparatus 100. The management monitor 139 is, for example, a liquid crystal panel, and a touch panel 142 is superimposed on its surface. The management monitor 139 presents various menu items related to training settings, various parameter values for training, training results, etc. The operator 910 selects, corrects, or adds setting items using the touch panel 142 or a keyboard (not shown). The management monitor 139 is installed at a position where the training person 900 cannot see the display of the management monitor 139 from a position where the training person undergoes a training attempt on the treadmill 131. A part for supporting the management monitor 139 may include a rotating mechanism for reversing the display surface to enable the operator 910 to show the display screen to the training person 900 when the operator 910 has an intention to do so.

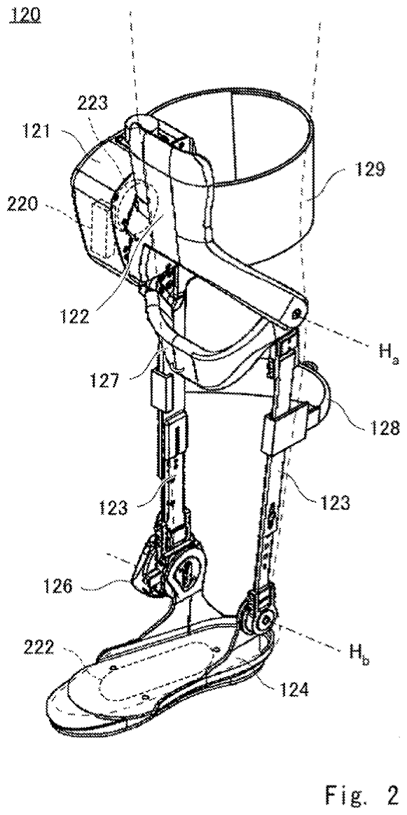

The walking assistance apparatus 120 is worn on the training person 900's diseased leg and assists the training person 900 to walk by reducing the burden of extending and bending motions in the knee joint of the diseased leg. FIG. 2 is a schematic perspective view of the walking assistance apparatus 120. The walking assistance apparatus 120 mainly includes a control unit 121, a plurality of frames for supporting respective parts of the diseased leg, and a load sensor 222 for detecting a load applied to the sole of the foot.

The control unit 121 includes an assistance control unit 220 for controlling the walking assistance apparatus 120, and also includes a motor (not shown) for generating a driving force for assisting extending and bending motions in the knee joint. The frame supporting each part of the diseased leg includes a thigh frame 122, a lower leg frame 122 that is connected to lower leg frames 123 in such a way that the thigh frame 122 can rotationally move, a foot sole frame 124 connected to the lower leg frames 123 in such a way that the foot sole frame 124 can rotationally move, a front connection frame 127 for connecting the front wire 134, and a rear connection frame 136 for connecting the rear side wire 128. The front connection frame 127 is extended in the horizontal direction on the front side of the thigh and is connected to the thigh frame 122 at both ends of the front connection frame 127. The rear connection frame 128 is extended in the horizontal direction on the rear side of the lower leg and is connected to the lower leg frames 123 that are extended vertically at both ends of the rear connection frame 128, respectively.

The thigh frame 122 and the lower leg frames 123 relatively and rotationally move around a hinge axis Hₐ shown in the drawing. The motor of the control unit 121 rotates in accordance with an instruction of the assistance control unit 220, and assists the thigh frame 122 and the lower leg frames 123 to relatively open around the hinge axis Hₐ or assists the thigh frame 122 and the lower leg frames 123 to close. An angle sensor 223 accommodated in the control unit 121 is, for example, a rotary encoder, and detects an angle formed between the thigh frame 122 and the lower leg frames 123 around the hinge axis Hₐ. The lower leg frame 123 and the foot sole frame 124 relatively and rotationally move around the hinge axis H_{b} shown in the drawing. An angular range within which the lower leg frame 123 and the foot flat frame 123 relatively and rotationally move is previously adjusted by an adjustment mechanism 126.

The thigh frame 122 includes a thigh belt 129. The thigh belt 129 is provided integrally with the thigh frame, and is wound around the thigh of the diseased leg to fix the thigh frame 122 to the thigh. This prevents the entire walking assistance apparatus 120 from shifting with respect to the training person 900's leg.

The load sensor 222 is a load sensor embedded in the foot sole frame 124. The load sensor 222 detects magnitude and distribution of a vertical load applied to the training person 900's sole. The load sensor 222 is, for example, a load detection sheet of a resistance change detection type including electrodes arranged in a matrix.

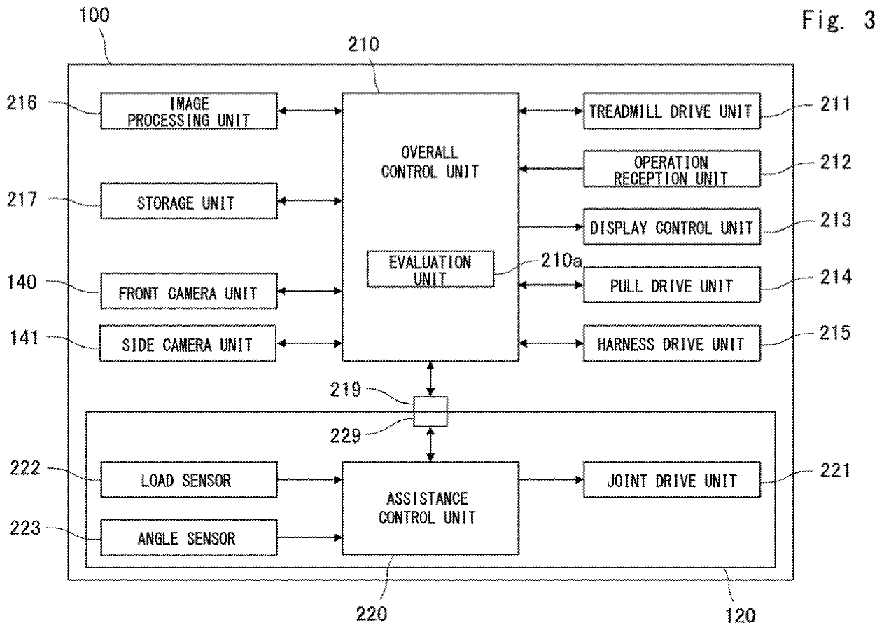

Next, a system configuration of the walking training apparatus 100 will be described. FIG. 3 is a system configuration diagram of the walking training apparatus 100. The overall control unit 210 is, for example, an MPU, and controls the entire apparatus by executing a control program read from a storage unit 217. The treadmill drive unit 211 includes a motor for rotating the belt 132 and a drive circuit for the motor. The overall control unit 210 controls the rotation of the belt 132 by sending a drive signal to the treadmill drive unit 211. For example, the overall control unit 210 adjusts a rotational speed of the belt 132 to a set training level.

An operation reception unit 212 includes various input apparatuses that receive input operations from the training person 900 and the operator 910, and transmit operation signals to the overall control unit 210. The touch panel 142 is one of the operation reception unit 212. The training person 900 or the operator 910 operates an operation button, a touch panel, an accompanying remote control, etc. which constitute the operation reception unit 212 to give an instruction to turn on/off the power supply or start training, to input numerical values related to settings, and to select menu items. The operation reception unit 212 may include a voice interaction apparatus and an image recognition apparatus.

The display control unit 213 generates a display video in accordance with a control signal from the overall control unit 210, and displays the display video on the training monitor 138 or the management monitor 139. The display control unit 213 generates video or the like showing the progress of training. More specifically, as will be described later in detail, the display control unit 213 converts training objective items of a first group from among a plurality of training objective items into a display video and displays it on the management monitor 139. Then, the display control unit 213 converts, into a display video, training objective items of a second group selected from among the training objective items of the first group displayed on the management monitor 139 selected through the display on the management monitor 139 and displays the display video on the training monitor 138.

A pull drive unit 214 includes a motor for pulling the front wire 134 and a drive circuit for the motor, and a motor for pulling the rear wire 136 and a drive circuit for the motor. The overall control unit 210 controls each of the winding of the front wire 134 and the winding of the rear wire 136 by sending a drive signal to the pull drive unit 214. A force for pulling each wire is controlled not only by a winding operation but also by controlling a driving torque of the motor. The overall control unit 210 assists a swinging motion of the diseased leg by, for example, identifying, from a result of the detection by the load sensor 222, a timing at which the diseased leg is switched from a leg-standing state to a leg-swinging state, and increasing or decreasing the force for pulling each wire in synchronization with the identified timing.

A harness drive unit 215 includes a motor for pulling the harness wire 111 and a drive circuit for the motor. The overall control unit 210 controls winding of the harness wire 111 and a force for pulling the harness wire 111 by sending a drive signal to the harness drive unit 215. For example, when the training person 900 greatly loses his/her posture, the overall control unit 210 winds the harness wire 111 by a predetermined amount to prevent the training person from falling down.

The image processing unit 216 performs image processing on the image signals received from the front camera unit 140 and the side camera unit 141 in accordance with the control signal from the overall control unit 210 and generates image data. The image processing unit 216 can also perform a specific image analysis by performing image processing on the image signals received from the front camera unit 140 and the side camera unit 141 in accordance with an instruction from the overall control unit 210. For example, the positions of shoulders and a hip joint can be detected from information such as extracted edges. Such positional information serve as basic information for evaluating the state of the trunk, legs, and foot soles while the training person 900 is moving his/her legs.

The storage unit 217 includes a non-volatile storage medium such as a solid state drive. The non-volatile storage medium stores, in addition to a control program for controlling the walking training apparatus 100, various parameter values used for control and calculation, functions, and lookup tables, etc. In particular, the storage unit 217 stores a plurality of training objective items that the training person can be trained for in the walking training apparatus 100 and evaluation comments that can be presented to the training person. The storage unit 217 includes a volatile storage medium such as a DRAM. The volatile storage medium functions not only as a work memory used by the overall control unit 210 or the like when calculations and processing are being executed, but also as a temporary memory for temporarily storing evaluation of training attempts and video data.

The front camera unit 140 and the side camera unit 141 repeat an image-capturing operation in accordance with the control signal from the overall control unit 210, and output the image signal to the image processing unit 216. The overall control unit 210 also functions as a function execution unit for executing various calculations and controls related to control. An evaluation unit 210a evaluates rehabilitation training undergone by the training person 900. The evaluation unit 210a evaluates, for example, whether a walking motion is normal using an analysis result of the image processing unit 216 and evaluates a walking distance and a walking speed using drive information of the treadmill 131.

As described above, the walking assistance apparatus 120 is worn on the training person 900's diseased leg. The walking training apparatus 100 includes a communication connection IF 219 connected to the overall control unit 210 for issuing a command to the walking assistance apparatus 120 and receiving sensor information. The walking assistance apparatus 120 also includes a communication connection IF 229 connected to the communication connection IF 219 in a wired or wireless manner. The communication connection IF 229 is connected to the assistance control unit 220 of the walking assistance apparatus 120. The communication connection IFs 219 and 229 are communication interfaces such as, for example, a wireless LAN conforming to communication standards.

The assistance control unit 220 is, for example, an MPU, and controls the walking assistance apparatus 120 by executing a control program provided from the overall control unit 210. The state of the walking assistance apparatus 120 is transmitted to the overall control unit 210 via the communication connection IFs 219 and 229. In response to a command from the overall control unit 210, the assistance control unit 220, for example, starts or stops the walking assistance apparatus 120.

A joint drive unit 221 includes a motor of the control unit 121 and a drive circuit for the motor. The assistance control unit 220 assists the thigh frame 122 and the lower leg frames 123 to relatively open around the hinge axis Hₐ or assists the thigh frame 122 and the lower leg frames 123 to close by sending a drive signal to the joint drive unit 221. Such an operation assists the extending and bending motions of the knee, and prevents the knee from giving out. The load sensor 222 detects magnitude and distribution of a vertical load applied to the training person 900's sole as described above, and transmits a detection signal to the assistance control unit 220.

The assistance control unit 220 receives the detection signal and analyzes it to thereby determine whether the leg is in the leg-swinging state or the leg-standing state and estimate a switching timing between the leg-swinging state and the leg-standing state. As described above, the angle sensor 223 detects an angle formed between the thigh frame 122 and the lower leg frames 123 around the hinge axis Hₐ, and transmits a detection signal to the assistance control unit 220. The assistance control unit 220 receives the detection signal and calculates an opening angle of the knee joint.

Here, an example of an evaluation method performed by the evaluation unit 210a will be further described. The evaluation unit 210a calculates an inclination of the training person 900's trunk who is walking based on a result of the analysis on the training person's images captured by the front camera unit 140 and the side camera unit 141 by the image processing unit 216. Specifically, reference positions of the main skeleton, such as positions of shoulders and a hip joint, analyzed by the image processing unit 216 are connected to determine the trunk in the image, and an angle formed by a direction in which the trunk is extended and a vertical axis of the walking surface is calculated as an inclination angle. The evaluation unit 210a evaluates a gait of the training person 900 using the calculated inclination of the trunk. The evaluation unit 210a also considers the dragging and tripping while walking, grasping of the handrail 130a, and the like detected from the image analysis conducted by the image processing unit 216 and an output of a sensor such as the load sensor 222 as objects in order to evaluate the gait.

An abnormal gait judgment can be based on, for example, the following seven criteria. A first criterion is whether a distance along a walking direction from the hip joint to the ankle joint when the diseased leg lands after a leg-swinging phase is greater than or equal to a reference value. When this distance is less than the reference value, the gait is evaluated as abnormal walking, because the diseased leg could not be swung sufficiently. A second criterion is whether a load on the sole is detected during the leg-swinging phase of the diseased leg. When the load on the sole is detected during the leg-swinging phase of the diseased leg, the gait is evaluated as abnormal walking, because the leg has been dragged. A third criterion is whether a flexion angle of the knee joint during the leg-standing state of the diseased leg is greater than or equal to a reference angle. When the flexion angle of the knee joint is less than the reference angle, the gait is evaluated as abnormal walking, because a force of the hip joint for supporting the upper body is insufficient.

A fourth criterion is whether a distance along the walking direction from the hip joint to the ankle joint when the diseased leg is swung at the time of switching from the leg-standing phase to the leg-swinging phase is greater than or equal to a reference value. When this distance is less than the reference value, the gait is evaluated as abnormal walking, because the weight of the upper body could not have shifted freely. A fifth criterion is whether an inclination angle of the trunk in the forward direction during the leg-standing state of the diseased leg is greater than or equal to a reference angle. When this angle is greater than or equal to the reference angle, the gait is evaluated as abnormal walking, because of the forward leaning posture. A sixth criterion is whether the inclination angle of the trunk toward the diseased leg during the leg-standing state of the diseased leg is greater than or equal to a reference angle. When this angle is greater than or equal to the reference angle, the gait is evaluated as abnormal walking, because the shake of the trunk in the horizontal direction is large.

A seventh criterion is whether the inclination angle of the trunk in the forward direction during the leg-swinging phase of the diseased leg is greater than or equal to a reference angle. When this angle is less than the reference angle, the gait is evaluated as abnormal walking, because the weight of the upper body could not have shifted freely, and the training person 900 is bent backward. Note that the respective reference values and reference angles may be changed in accordance with the training person 900's age, the level of training attempts, etc. In addition to the abnormal walking and a level of the abnormal walking determined in this manner, the evaluation unit 210a determines the evaluation for predetermined evaluation items such as a walking distance, a walking speed, a walking duration, an average stride length, levels of assistance by the front pulling part 135 and the rear pulling part 137, the presence or absence of relief by the harness pulling part 112, and the level of assistance by the walking assistance apparatus 120.

The overall control unit 210 controls training attempts to be undergone by the training person 900 based on the selected specific training objective item(s). For example, when the training objective item “Let's walk 100 meters” is selected, a training menu that an amount of driving of the treadmill 131 is not less than 100 m is executed. When the training objective item “Try to raise your body and walk” is selected, the training person 900's posture during the training attempt is observed so that the evaluation unit 210a makes an evaluation including an evaluation item of “whether training person is walking while keeping his/her body raised”.

The training objective items to be selected should desirably be determined by a physical therapist or physician who is an expert, judging the training person 900's severity level of the illness with expert knowledge. The training objective items thus determined may be appropriate in terms of the training person 900's physical condition but may not be appropriate in terms of his/her mental condition such as the mood in the training or fear for the training attempt. The training person 900 may feel reluctant or be discouraged from undergoing rehabilitation training according to the training objective items automatically selected by a training apparatus or forced upon the training person by an expert. On the other hand, it may not be desirable to allow the training person 900 to freely select the training objective item in order to achieve an expected training effect.

Thus, in the walking training apparatus 100, the operator 910 first selects a plurality of training objective items suitable for the training person 900 from among the training objective items prepared in advance. Then, the selected training objective items are presented to the training person 900, and the training person 900 selects and determines a specific training objective item from the presented training objective items according to his/her own will. At this time, the training person 900 can listen to the operator 910's advice to select a specific training objective item together with the operator 910. When such a procedure is followed, it can be expected that the training person 900 actively undergoes rehabilitation training in accordance with the training objective item expected to be effective. The procedures for selecting and determining a specific training objective item are described below.

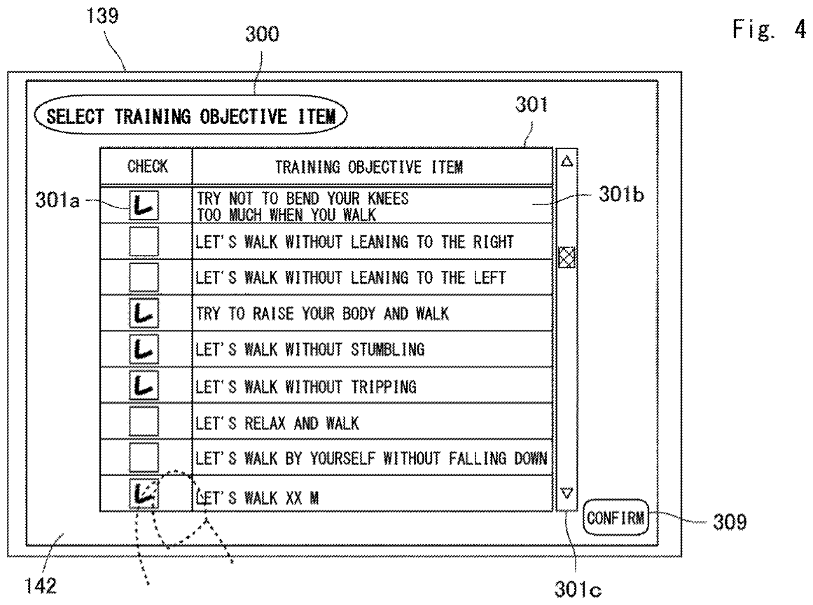

FIG. 4 shows an example of the training objective item selection screen displayed on the management monitor 139. The operator 910 specifies a plurality of training objective items suitable for the training person 900 on the selection screen as shown in the drawing.

The overall control unit 210 displays an item list 301 on the management monitor 139 together with a title 300 “Select Training Objective” through the display control unit 213. The training objective items are previously stored in the storage unit 217, and the overall control unit 210 reads out all or some of the training objective items as a first group of training objective items to be displayed on the management monitor 139, and passes the training objective items to the display control unit 213. When some of the training objective items stored in the storage unit 217 are defined as the first group, the overall control unit 210 refers to, for example, the personal information of the training person 900, and generates the first group while excluding training objective items which are obviously inappropriate for a training attempt to be conducted from now on.

As shown in the drawing, the item list 301 is composed of a list of pairs of check boxes 301a and items 301b. When a scroll bar 301c does not fit in one screen, the scroll bar 301c may be arranged in such a way that the scroll bar 301 can be scrolled. The items 301b are training objective items of the first group read out from the storage unit 217 by the overall control unit 210. When the operator 910 touches the check box 301a arranged next to the item 301b, the item 301b is set in a selected state.

In the example shown in the drawing, the training objective items “Try not to bend your knees too much when you walk”, “Try to raise your body and walk”, “Let's walk without stumbling”, and “Let's walk without tripping” are selected. On the other hand, the training objective items “Let's walk without leaning to the right”, “Let's walk without leaning to the left”, “Let's relax and walk”, and “Let's walk by yourself without falling down” are not selected. The operator 910 does not select the training objective item “Let's walk by yourself without falling down”, for example, when the training person 900 is in an initial stage of rehabilitation training, and the operator 910 thinks that it is better to have support from behind the training person 900 for a while.

The operator 910 touches a confirm button 309 when the selection is completed to confirm the training objective items of the second group to be presented to the training person 900. It is desirable that the operator 910 performs this operation without letting the training person 900 see it. The management monitor 139 may be restricted from being executed so that the selection of the training objective item of the second group is executed by the operator 910. The management monitor 139 may be configured, for example, to display the item list 301 when the operator 910 inputs a password.

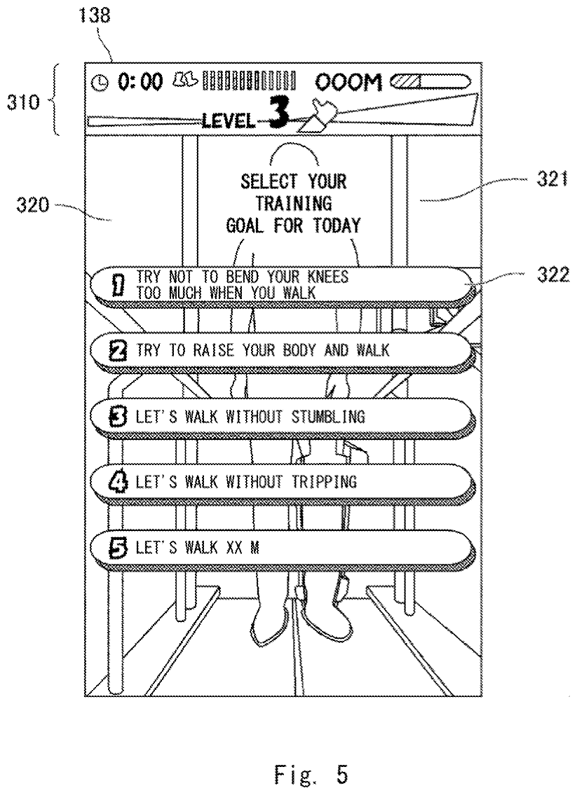

FIG. 5 shows an example of a training objective item selection screen displayed on the training monitor 138. The overall control unit 210 displays the training objective items of the second group selected by the operator 910 on the training monitor 138 through the display control unit 213.

A status area 310 is provided at the top of the training monitor 138, and status information for the training attempt is displayed in the status area 310. The status information includes an attempt duration, a walking distance, a training level, a score indicator, etc., and values of them are updated according to the progress of the training attempt. A camera image 320 is projected on an area other than the status area 310 of the training monitor 138. The camera image 320 is a full-body image of the training person 900 captured by the front camera unit 140 or the side camera unit 141, and is displayed as a real-time image of, for example, 60 fps.

A selected title 321 and presented items 322 are superimposed as CG on the camera image 320. The selected title 321 indicates content for prompting the training person 900 to select a training objective item such as “Select your training goal for today”. Each of the presented items 322 is the training objective item of the second group. Each presented item 322 is sequentially numbered to allow the training person 900 to easily select them.

The training person 900 selects one or more items to be the training objective item(s) of the training attempt to undergo in accordance with his/her own will while looking at the training monitor 138 displayed in the above-described manner. Specifically, when the touch panel is also superimposed on the training monitor 138 as the operation reception unit 212, the training person 900 touches the presented item 322 to be selected. Alternatively, when the training person 900 utters the number of the presented item 322 he/she desires to select, a voice identification apparatus as the operation reception unit 212 recognizes the number. Further alternatively, the operator 910 may hear the utterance and select the corresponding training objective item on the management monitor 139. The overall control unit 210 controls the training attempt based on the specific training objective item selected from among the training objective items of the second group.

The overall control unit 210 can also accept a numerical value of the presented item 322, which requires an input of a numerical value, for example, “Let's walk xx m”, on a touch panel or the like. The overall control unit 210 may convert the received numerical value into CG, embed it in the presented item 322, and present it. The overall control unit 210 controls the training attempt so as to correspond to the received numerical value.

While the overall control unit 210 controls the training attempt according to the selected specific training objective item, the evaluation unit 210a evaluates the training attempt of the training person 900, generates evaluation information, and sequentially stores the evaluation information in the storage unit 217. When the training person 900 completes the training attempt, the evaluation information is read from the storage unit 217 and presented to the training person 900. When the evaluation information is presented to the training person 900 without considering the training person 900's character or the like, the motivation of the training person 900 may be lowered. On the other hand, when only an evaluation comfortable for the training person to hear is given to the training person, the training person cannot understand what points to consider when he/she starts rehabilitation training, and the training effect is reduced. How each training person using the walking training apparatus 100 is affected by the comment depends on the training person's character, the condition of the affected part, the result of the previous training attempt, etc. Thus, in a manner similar to the training objective items, the overall control unit 210 first displays the evaluation information on the management monitor 139, and displays, on the training monitor 138, only the evaluation information selected by the operator 910 on the management monitor 139.

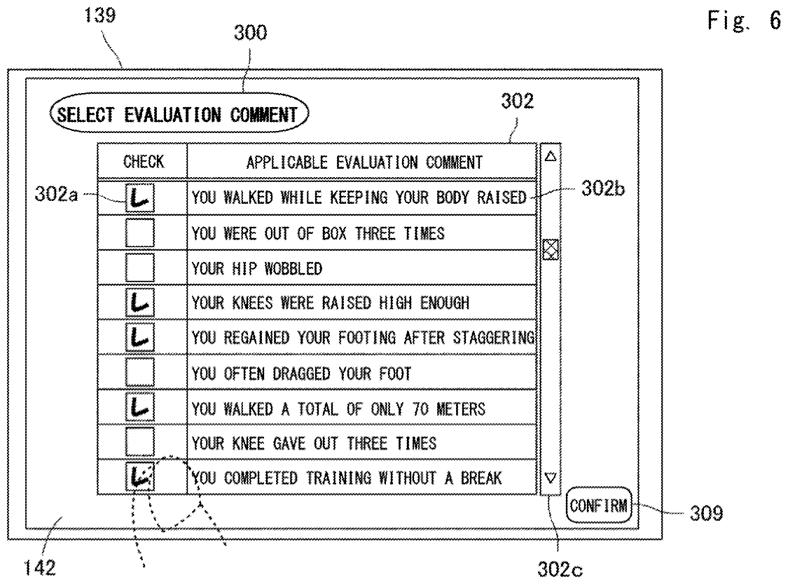

FIG. 6 shows an example of an evaluation comment selection screen displayed on the management monitor 139. The operator 910 specifies an evaluation comment(s) appropriate for the training person 900 on the selection screen as shown in the drawing.

The overall control unit 210 displays a comment list 302 on the management monitor 139 together with the title 300 of “Select Evaluation Comment” through the display control unit 213. The evaluation comments are stored in the storage unit 217, and the overall control unit 210 reads all or some of the evaluation comments corresponding to the evaluation information stored in the storage unit 217 through the training attempt as a first group to be displayed on the management monitor 139, and passes them to the display control unit 213. When some of the corresponding evaluation comment are defined as the first group, the overall control unit 210 refers to, for example, the personal information of the training person 900, and generates the first group while excluding clearly inappropriate evaluation comments such as an item that focuses on a body part unlikely to recover.

As shown in the drawing, the comment list 302 is composed of a list of pairs of check boxes 302a and comments 302b. When a scroll bar 302c does not fit in one screen, the scroll bar 302c may be arranged in such a way that the scroll bar 302c can be scrolled. The comments 302b are evaluation comments of the first group read out from the storage unit 217 by the overall control unit 210. When the operator 910 touches the check box 302a arranged next to the comment 302b, the comment 302b is set in a selected state.

In the example shown in the drawing, comments “You walked while keeping your body raised”, “Your knees were raised high enough”, “You regained your footing after staggering”, “You walked a total of only 70 meters”, and “You completed training without a break” are selected. On the other hand, the evaluation comments “You were out of box three times”, “Your hip wobbled”, “you often dragged your foot”, and “Your knee gave out three times” are not selected. The operator 910 touches the confirm button 309 when the selection is completed to confirm the training objective items of the second group to be presented to the training person 900. It is desirable that the operator 910 perform this operation without letting the training person 900 see it.

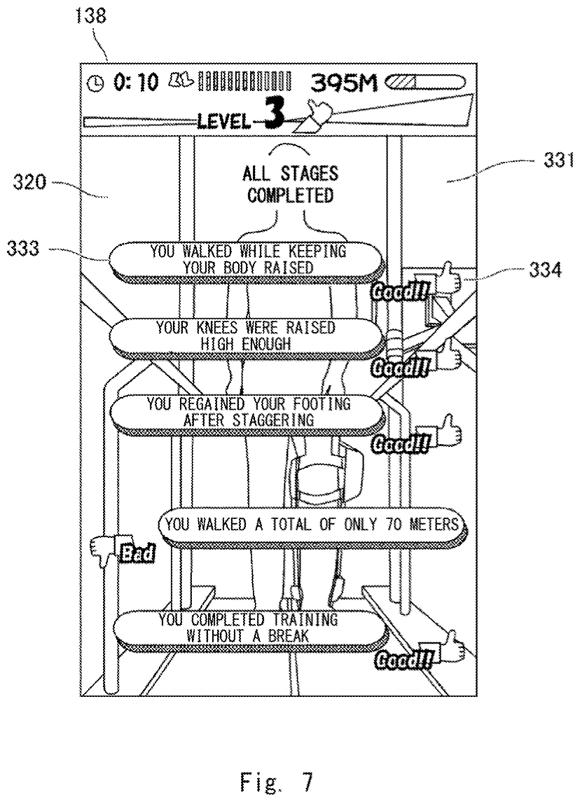

FIG. 7 shows an example of an evaluation comment selection screen displayed on the training monitor 138. The overall control unit 210 displays the evaluation comments of the second group selected by the operator 910 on the training monitor 138 through the display control unit 213.

A status title 331, presented comments 333, and attribute icons 334 are superimposed as CG on the camera image 320. The status title 331 indicates, for example, “All Stages Completed” to notify the training person 900 that the training attempt has been completed. Each of the presented comments 333 is the evaluation comment of the second group. The attribute icon 334 corresponding to the content of the presented comment 333 is disposed in the vicinity of the presented comment 333.

For example, when the presented comment 333 indicates the evaluation comment “You walked while keeping your body raised”, the attribute icon 334 “Good! !” is superimposed, because this evaluation comment is a positive comment. On the other hand, when the presented comment 333 indicates the evaluation comment “You walked a total of only 70 meters”, the attribute icon 334 “Bad” is superimposed, because this evaluation comment is a negative comment.

The training person 900 can review the last training attempt while watching the training monitor 138 displayed in the above-described manner. When an evaluation value shown as a numerical value is included in the evaluation comment, for example, “You walked a total of only 70 meters”, the overall control unit 210 embeds the numerical value converted by the evaluation unit 210a in the evaluation comment stored in the storage unit 217 to complete the evaluation comment to be displayed.

When a satisfactory gait is maintained or an undesirable gait occurs while the training person 900 is undergoing the training attempt, the evaluation unit 210a causes the image processing unit 216 to sequentially generate a video clip for a predetermined period of time, and stores the video clip in the storage unit 217. When the training person 900 completes the training attempt, the video clip is read from the storage unit 217 and then presented to the training person 900. When the video clip is presented to the training person 900 without considering the training person 900's character or the like, the motivation of the training person 900 may be lowered. On the other hand, when the video clip of the undesirable gait is not presented, the training person cannot understand how the unfavorable gait has happened. Thus, in a manner similar to the training objective items, the overall control unit 210 first displays the video clip on the management monitor 139, and displays, on the training monitor 138, only the video clip selected by the operator 910 on the management monitor 139.

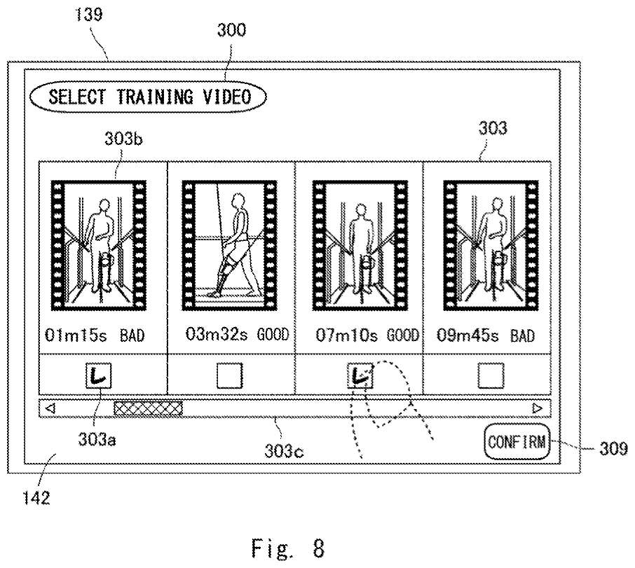

FIG. 8 shows an example of a video clip selection screen displayed on the management monitor 139. The operator 910 selects a video clip appropriate for the training person 900 on the selection screen shown in the drawing.

The overall control unit 210 displays a video list 303 on the management monitor 139 together with the title 300 of “Select Training Video” through the display control unit 213. The overall control unit 210 reads out all or some of the video clips generated through the training attempt from the storage unit 217 as a first group to be displayed on the management monitor 139, and passes them to the display control unit 213.

As shown in the drawing, the video list 303 is composed of a list of pairs of check boxes 303a and videos 303b. When a scroll bar 303c does not fit in one screen, the scroll bar 303c may be arranged in such a way that the scroll bar 303c can be scrolled. The videos 303b are video clips of the first group read out from the storage unit 217 by the overall control unit 210. When the operator 910 touches the check box 303a arranged under the video 303b, the video 303b is set in a selected state.

In the example shown in the drawing, a video clip of a bad gait captured at 1 minute 15 seconds and a video clip of a good gait captured at 7 minutes 10 seconds are selected. The operator 910 touches the confirm button 309 when the selection is completed to confirm the video clip(s) of the second group to be presented to the training person 900. It is desirable that the operator 910 performs this operation without letting the training person 900 see it.

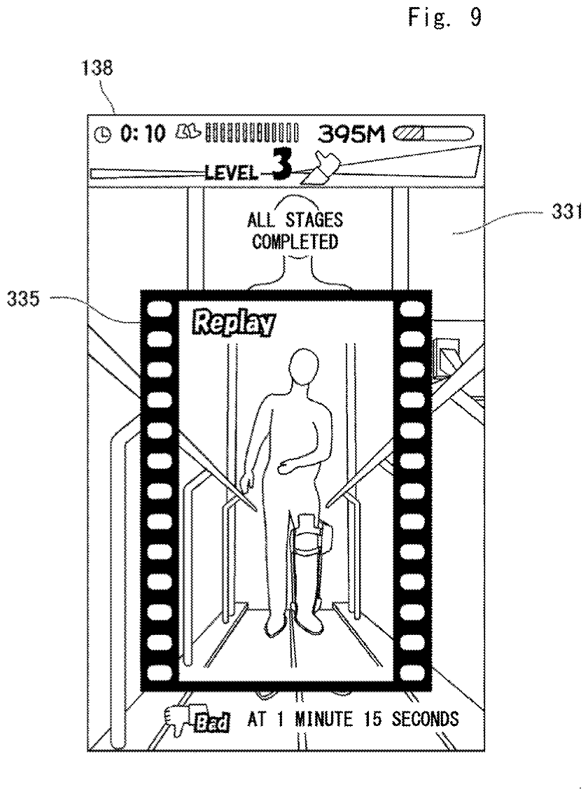

FIG. 9 shows an example of a training video display screen displayed on the training monitor 138. The overall control unit 210 sequentially displays the video clips of the second group selected by the operator 910 on the training monitor 138 via the display control unit 213.

A status title 331, a presented video 335, an attribute icon 334, and a caption 336 are superimposed as CG on the camera image 320. The presented video 335 is one of the video clips of the second group, and the video clips selected as the second group are sequentially reproduced as the presented video 335. The attribute icon 334 and the caption 336 corresponding to content of the video clip are arranged in the vicinity of the presented video 335. An icon corresponding to “Good!” or “Bad” is selected as the attribute icon 334 according to the reason for generating the video clip. The caption 336 indicates information about the video clip, such as the time when this video clip is captured. The training person 900 can review the last training attempt while watching the training monitor 138 displayed in the above-described manner.

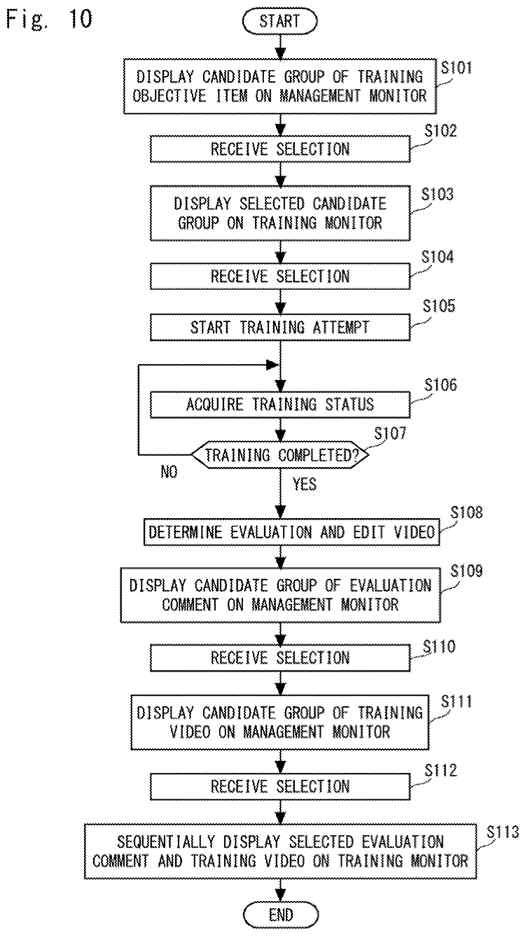

FIG. 10 shows a processing flow of the walking training apparatus 100 in a series of training attempts. In Step S101, as described with reference to FIG. 4, the overall control unit 210 reads the training objective items of a preset candidate group (first group) from among the training objective items stored in the storage unit 217, and displays them on the management monitor 139 through the display control unit 213. At this time, it is desirable that the training person 900 cannot see the display screen of the management monitor 139 from where he/she undergoes a training attempt.

In Step S102, the overall control unit 210 receives the selection of the training objective items of the second group from the operator 910 through, for example, the touch panel 142. When the training objective item of the second group is determined, the overall control unit 210 proceeds to Step S103 and, as described with reference to FIG. 5, displays the training objective items of the second group on the training monitor 138 through the display control unit 213. In Step S104, the overall control unit 210 receives the training objective item(s) according to the training person 900's will through the operation reception unit 212. The overall control unit 210 proceeds to Step S105, and starts a training attempt for the training person 900 so as to correspond to the determined specific training objective item.

When the training attempt is started, the overall control unit 210 acquires a status of the training in Step S106. More specifically, the overall control unit 210 controls the image processing unit 216 to acquire captured images captured by the front camera unit 140 and the side camera unit 141, perform image processing, and perform analysis processing for analyzing a gait. The overall control unit 210 also acquires the walking distance and the walking speed using information from the treadmill drive unit 211, and the average stride length using information from the load sensor 222 or the like. The overall control unit 210 also acquires a level of assistance provided by the walking assistance apparatus 120 using information from the front pulling unit 135 and the rear pulling unit 137, and understands whether a relief measure has been taken using information from the harness pulling unit 112. At this time, the evaluation unit 210a evaluates the gait using the analysis result and the like, or causes the image processing unit 216 to generate a video clip related to the evaluation.

In Step S107, the overall control unit 210 determines whether the scheduled training attempt has been completed. When it is determined that the scheduled training attempt has not been completed, the overall control unit 210 returns to Step S106. When it is determined that the scheduled training attempt has been completed, the overall control unit 210 proceeds to Step S108.

In Step S108, the evaluation unit 210a performs an evaluation determination on a series of training attempts. More specifically, the status of the training acquired in Step S106 and the sequentially-determined evaluations are applied to a preset evaluation criterion, and the evaluation comments matching a result of the application are read from the storage unit 217. The video clip generated during the training attempt is read from the storage unit 217 and edited into a format suitable for display.

The overall control unit 210 proceeds to Step S109, and as described with reference to FIG. 6, the evaluation comments (evaluation comments of the first group) read from the storage unit 217 are displayed on the management monitor 139 through the display control unit 213. In Step S110, the overall control unit 210 receives the selection of the evaluation comments of the second group from the operator 910 through the touch panel 142 or the like and confirms the evaluation comments. The overall control unit 210 proceeds to Step S111, and as described with reference to FIG. 8, the video clips (video clips of the first group) read from the storage unit 217 are displayed on the management monitor 139 through the display control unit 213. In Step S112, the overall control unit 210 receives the selection of the video clip(s) of the second group from the operator 910 through the touch panel 142 or the like and confirms the video clip(s).

The overall control unit 210 proceeds to Step S113, and displays the selected evaluation comment(s) on the training monitor 138 through the display control unit 213 as described with reference to FIG. 7. After the evaluation comment(s) is displayed, the selected specific video clip is displayed on the training monitor 138 through the display control unit 213 as described with reference to FIG. 9. The training person 900 can review the last training attempt using the displayed comment(s) and the video clip thus displayed. When the display of the evaluation comment and the video clip is completed, the overall control unit 210 ends the series of processing.

In the above processing flow, when there is only one training objective item, evaluation comment, and video clip to be specified in the first group, the operator 910 may specify one of them as the second group. However, in regard to the training objective items, a plurality of training objective items may be defined as a second group so that the training person 900 can actively specify the training objective items in Step S104.

Although the walking training apparatus 100 has been described as an example of the rehabilitation training system according to this embodiment, the above concept can be applied to a rehabilitation training system in which a training objective item is set, and the training person undergoes a training attempt. Such a rehabilitation training system can make the training person actively undergo rehabilitation training in accordance with the training objective item expected to be effective. The rehabilitation training system does not need to include all the essential elements in one apparatus as in the above-described walking training apparatus 100. In other words, a system configuration of the rehabilitation training system may be the one in which, for example, an apparatus for the training person to undergo the training is connected to a server or a storage apparatus via an external network. With such a configuration, it is possible to use an external large storage apparatus for reading and writing a large amount of data, and to use a CPU of the server for performing a complicated training evaluation.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A rehabilitation training system comprising:
a storage unit configured to store a plurality of training objective items;
a first monitor installed at a position not visible from a position where a training person undergoes a training attempt and configured to display a training objective item of a first group from among the plurality of training objective items;
a second monitor installed at a position visible from the position and configured to display a training objective item of a second group selected through the display on the first monitor from among the training objective items of the first group; and
a control unit configured to control the training attempt to be undergone by the training person based on a specific training objective item selected through the display on the second monitor from among the training objective items of the second group.

2. The rehabilitation training system according to claim 1, wherein
the selection of the training objective item of the second group made through the display on the first monitor is restricted from being executed so that the training objective item of the second group is selected by an assistant, not the training person.

3. The rehabilitation training system according to claim 1, wherein
the storage unit is configured to store a plurality of evaluation information pieces regarding an evaluation of the training attempt undergone by the training person,
the first monitor is configured to display an evaluation information piece of a first group from among the plurality of evaluation information pieces, and
the second monitor is configured to display an evaluation information piece of a second group selected through the display on the first monitor from among the evaluation information pieces of the first group.

4. The rehabilitation training system according to claim 3, wherein
the plurality of evaluation information pieces include at least one of an evaluation comment on the training attempt, an evaluation value converted into a numerical value, and a video obtained by capturing a state of the training attempt.

5. A non-transitory computer readable medium storing a control program of a rehabilitation training system causing a computer to execute:
reading a training objective item of a preset first group from among a plurality of training objective items stored in a storage unit and displaying the training objective item of the first group on a first monitor installed at a position where the first monitor cannot be seen from a position where a training person undergoes a training attempt;
receiving a selection of a training objective item of a second group from among the training objective items of the first group;
displaying the training objective item of the second group on a second monitor installed at a position where the second monitor can be seen from the position;
receiving a selection of a specific training objective item from among the training objective items of the second group; and
controlling a training attempt to be undergone by the training person based on the specific training objective item.

6. A method for controlling a rehabilitation training system, the method comprising:
reading a training objective item of a preset first group from among a plurality of training objective items stored in a storage unit and displaying the training objective item of the first group on a first monitor installed at a position where the first monitor cannot be seen from a position where a training person undergoes a training attempt;
receiving a selection of a training objective item of a second group from among the training objective items of the first group;
displaying the training objective item of the second group on a second monitor installed at a position where the second monitor can be seen from the position;
receiving a selection of a specific training objective item from among the training objective items of the second group; and
controlling a training attempt to be undergone by the training person based on the specific training objective item.
